(19) United States
(12) Patent Application Publication
(10) Pub. No.: US 2026/0189133 A1
(43) Pub. Date: Jul. 2, 2026

(54) CONTROLLER FOR MAKING A POWER CONVERTER START UP NORMALLY AND OPERATIONAL METHOD THEREOF

(71) Applicant: Leadtrend Technology Corp., Hsinchu County (TW)

(72) Inventors: Chao-Chih Lin, Hsinchu County (TW); Ming-Chang Tsou, Hsinchu County (TW); Ming-Yen Lin, Hsinchu County (TW); Yun-Keng Cheng, Hsinchu County (TW)

(73) Assignee: Leadtrend Technology Corp., Hsinchu County (TW)

(21) Appl. No.: 19/402,916

(22) Filed: Nov. 26, 2025

Related U.S. Application Data
(60) Provisional application No. 63/739,662, filed on Dec. 29, 2024.

(51) Int. Cl. H02M 1/36; H02M 1/00; H02M 1/08

(52) U.S. Cl. CPC H02M 1/36; H02M 1/0009; H02M 1/0085; H02M 1/0095; H02M 1/08

(57) ABSTRACT

A controller for making a power converter start up normally includes a detection circuit, an upper-bridge power supply pre-charge circuit and a driving signal generation circuit. During the power converter starting up, the detection circuit detects a feedback voltage and adjusts the lower-bridge turning-on time of a lower-bridge switch driving signal of a lower-bridge switch of the power converter according to the feedback voltage. The upper-bridge power supply pre-charge circuit generates the lower-bridge switch driving signal according to the lower-bridge turning-on time and stops generating the lower-bridge switch driving signal when the feedback voltage meets a first predetermined condition. When the upper-bridge power supply pre-charge circuit stops generating the lower-bridge switch driving signal, the driving signal generation circuit generates the lower-bridge switch driving signal to the lower-bridge switch and an upper-bridge switch driving signal to an upper-bridge switch of the power converter to make the power converter operate normally.

### CROSS REFERENCE TO RELATED APPLICATIONS

This application claims the benefit of U.S. Provisional Application No. 63/739,662, filed on December 29th, 2024. The content of the application is incorporated herein by reference.

### BACKGROUND OF THE INVENTION

### 1. FIELD OF THE INVENTION

The present invention relates to a controller and an operational method thereof, and particularly to a controller that can make a power converter start up normally and an operational method thereof.

### 2. DESCRIPTION OF THE PRIOR ART

When an inductor-inductor-capacitor (LLC) half-bridge power converter starts up, if a lower-bridge switch installed at a primary side of the LLC half-bridge power converter is not first conducted to make an upper-bridge power supply voltage VHVCC reach a predetermined value, a controller installed at the primary side of the LLC half-bridge power converter cannot output an upper-bridge switch driving signal to an upper-bridge switch installed at the primary side of the LLC half-bridge power converter. Therefore, before the upper-bridge switch is conducted, the lower-bridge switch is usually first conducted to achieve an effect of self-boosting pre-charging to make the upper-bridge switch conducted normally. However, when a voltage on a resonant capacitor coupled to the lower-bridge switch is higher and an output voltage of a secondary side of the power converter is lower, conducting the lower-bridge switch may make a large current flow through the lower bridge switch, thereby damaging the lower bridge switch.

Therefore, the prior art provides two solutions to solve the above-mentioned problem, first, the lower-bridge switch is designed as a device which can endure a large current, but cost of the LLC half-bridge power converter will increase accordingly; second, a discharge resistor is connected in parallel with the resonant capacitor to release power, but standby power consumption of the LLC half-bridge power converter will increase by tens of milliwatts accordingly.

Therefore, how to design the controller for making the power converter start up normally has become an important issue of a designer of the controller.

### SUMMARY OF THE INVENTION

An embodiment of the present invention provides a controller for making a power converter start up normally. The controller includes a detection circuit, an upper-bridge power supply pre-charge circuit and a driving signal generation circuit. The detection circuit is used for detecting a feedback voltage during the power converter starting up, and adjusting a lower-bridge turning-on time of a lower-bridge switch driving signal of a lower-bridge switch of the power converter according to the feedback voltage. The upper-bridge power supply pre-charge circuit is coupled to the detection circuit, wherein the upper-bridge power supply pre-charge circuit generates the lower-bridge switch driving signal according to the lower-bridge turning-on time, and stops generating the lower-bridge switch driving signal when the feedback voltage meets a first predetermined condition, wherein the first predetermined condition relates to a feedback peak voltage of the feedback voltage. The driving signal generation circuit is coupled to the upper-bridge power supply pre-charge circuit for generating the lower-bridge switch driving signal to the lower-bridge switch and an upper-bridge switch driving signal to an upper-bridge switch of the power converter to make the power converter operate normally after upper-bridge power supply pre-charge circuit stops generating the lower-bridge switch driving signal.

According to one aspect of the present invention, the detection circuit receives the feedback voltage from outside the controller, and the first predetermined condition is that the feedback peak voltage of the feedback voltage is less than a reference voltage or the feedback peak voltage of the feedback voltage maintains at a stable value within a predetermined number cycles.

According to one aspect of the present invention, the lower-bridge turning-on time of the lower-bridge switch driving signal has a minimum turning-on time or a maximum turning-on time.

According to one aspect of the present invention, the feedback voltage relates to a resonant capacitor voltage on a resonant capacitor coupled to the lower-bridge switch and a resonant capacitor current flowing through the lower-bridge switch, and the lower-bridge switch, the resonant capacitor and the controller are installed at a primary side of the power converter.

According to one aspect of the present invention, the detection circuit gradually increases the lower-bridge turning-on time of the lower-bridge switch driving signal according to the feedback voltage or adjusts the lower-bridge turning-on time of the lower-bridge switch driving signal according to the feedback voltage.

According to one aspect of the present invention, the controller further includes a frequency controller, wherein the frequency controller is used for generating a controller clock with a predetermined frequency, and the controller clock makes the lower-bridge switch driving signal and the upper-bridge switch driving signal have the predetermined frequency.

According to one aspect of the present invention, the power converter is an inductor-inductor-capacitor (LLC) half-bridge resonant power converter or an asymmetrical half-bridge (AHB) flyback power converter.

Another embodiment of the present invention provides a controller for making a power converter start up normally. The controller includes a detection circuit, an upper-bridge power supply pre-charge circuit and a driving signal generation circuit. The detection circuit is used for detecting a peak value of a resonant capacitor current flowing through a lower-bridge switch of the power converter during the power converter starting up. The upper-bridge power supply pre-charge circuit is coupled to the detection circuit, wherein the upper-bridge power supply pre-charge circuit adjusts a lower-bridge turning-on time of a lower-bridge switch driving signal of the lower-bridge switch according to the peak value of the resonant capacitor current, and the upper-bridge power supply pre-charge circuit generates the lower-bridge switch driving signal according to the lower-bridge turning-on time and stops generating the lower-bridge switch driving signal when the peak value of the resonant capacitor current meets a second predetermined condition. The driving signal generation circuit is coupled to the upper-bridge power supply pre-charge circuit for generating the lower-bridge switch driving signal to the lower-bridge switch and an upper-bridge switch driving signal to an upper-bridge switch of the power converter to make the power converter operate normally after the upper-bridge power supply pre-charge circuit stops generating the lower-bridge switch driving signal.

According to one aspect of the present invention, the detection circuit receives the resonant capacitor current from outside the controller, and the second predetermined condition is that the peak value of the resonant capacitor current is less than a reference current.

According to one aspect of the present invention, the upper-bridge power supply pre-charge circuit gradually increases the lower-bridge turning-on time of the lower-bridge switch driving signal according to the resonant capacitor current or adjusts the lower-bridge turning-on time of the lower-bridge switch driving signal according to the resonant capacitor current.

Another embodiment of the present invention provides an operational method of a controller which makes a power converter start up normally, wherein the controller includes a detection circuit, an upper-bridge power supply pre-charge circuit and a driving signal generation circuit. The operational method includes the detection circuit detecting a feedback voltage during the power converter starting up, and adjusting a lower-bridge turning-on time of a lower-bridge switch driving signal of a lower-bridge switch of the power converter according to the feedback voltage; the upper-bridge power supply pre-charge circuit generating the lower-bridge switch driving signal according to the lower-bridge turning-on time; the upper-bridge power supply pre-charge circuit stopping generating the lower-bridge switch driving signal when the feedback voltage meets a first predetermined condition, wherein the first predetermined condition relates to a feedback peak voltage of the feedback voltage; and the driving signal generation circuit generating the lower-bridge switch driving signal to the lower-bridge switch and an upper-bridge switch driving signal to an upper-bridge switch of the power converter to make the power converter operate normally after upper-bridge power supply pre-charge circuit stops generating the lower-bridge switch driving signal.

According to one aspect of the present invention, the first predetermined condition is that the feedback peak voltage of the feedback voltage is less than a reference voltage or the feedback peak voltage of the feedback voltage maintains at a stable value within a predetermined number cycles.

According to one aspect of the present invention, the lower-bridge turning-on time of the lower-bridge switch driving signal has a minimum turning-on time or a maximum turning-on time.

According to one aspect of the present invention, the feedback voltage relates to a resonant capacitor voltage on a resonant capacitor coupled to the lower-bridge switch and a resonant capacitor current flowing through the lower-bridge switch.

According to one aspect of the present invention, wherein the detection circuit gradually increases the lower-bridge turning-on time of the lower-bridge switch driving signal according to the feedback voltage or adjusts the lower-bridge turning-on time of the lower-bridge switch driving signal according to the feedback voltage.

Another embodiment of the present invention provides an operational method of a controller which makes a power converter start up normally, wherein the controller includes a detection circuit, an upper-bridge power supply pre-charge circuit and a driving signal generation circuit. The operational method includes the detection circuit detecting a peak value of a resonant capacitor current flowing through a lower-bridge switch of the power converter during the power converter starting up; the upper-bridge power supply pre-charge circuit adjusting a lower-bridge turning-on time of a lower-bridge switch driving signal of the lower-bridge switch according to the peak value of the resonant capacitor current, and generating the lower-bridge switch driving signal according to the lower-bridge turning-on time; the upper-bridge power supply pre-charge circuit stopping generating the lower-bridge switch driving signal when the peak value of the resonant capacitor current meets a second predetermined condition; and the driving signal generation circuit generating the lower-bridge switch driving signal to the lower-bridge switch and an upper-bridge switch driving signal to an upper-bridge switch of the power converter to make the power converter operate normally after the upper-bridge power supply pre-charge circuit stops generating the lower-bridge switch driving signal.

According to one aspect of the present invention, the detection circuit receives the resonant capacitor current from outside the controller, and the second predetermined condition is that the peak value of the resonant capacitor current is less than a reference current.

According to one aspect of the present invention, the upper-bridge power supply pre-charge circuit gradually increases the lower-bridge turning-on time of the lower-bridge switch driving signal according to the resonant capacitor current or adjusts the lower-bridge turning-on time of the lower-bridge switch driving signal according to the resonant capacitor current.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a controller for making a power converter start up normally according to a first embodiment of the present invention.

FIG. 2 is a waveform timing diagram illustrating the upper-bridge switch driving signal, the lower-bridge switch driving signal, the feedback voltage, the upper-bridge power supply voltage on the upper-bridge power supply storage capacitor, the resonant capacitor voltage on the resonant capacitor and the resonant capacitor current flowing through the lower-bridge switch.

FIG. 3 is a waveform timing diagram illustrating the upper-bridge switch driving signal, the lower-bridge switch driving signal, the feedback voltage, the upper-bridge power supply voltage on the upper-bridge power supply storage capacitor, the resonant capacitor voltage on the resonant capacitor and the resonant capacitor current flowing through the lower-bridge switch.

FIG. 4 is a waveform timing diagram illustrating the upper-bridge switch driving signal, the lower-bridge switch driving signal, the feedback voltage and the upper-bridge power supply voltage on the upper-bridge power supply storage capacitor if the feedback voltage has been lower than the reference voltage when the power converter starts up.

FIG. 5 is a flowchart illustrating an operational method of a controller which makes a power converter start up normally according to a second embodiment of the present invention.

FIG. 6 is a diagram illustrating a controller for making a power converter start up normally according to a third embodiment of the present invention.

FIG. 7 is a waveform timing diagram illustrating the upper-bridge switch driving signal, the lower-bridge switch driving signal, the feedback voltage, the upper-bridge power supply voltage on the upper-bridge power supply storage capacitor, the resonant capacitor voltage on the resonant capacitor and the resonant capacitor current flowing through the lower-bridge switch.

FIG. 8 is a flowchart illustrating an operational method of a controller which makes a power converter start up normally according to a fourth embodiment of the present invention.

### DETAILED DESCRIPTION

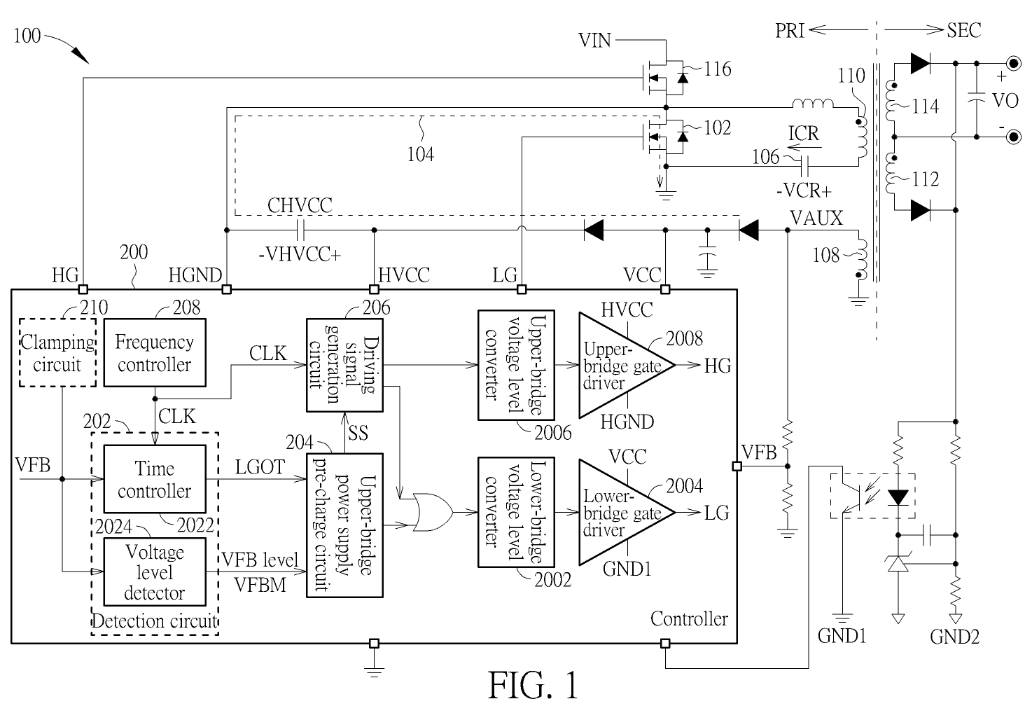

Please refer to FIG. 1. FIG. 1 is a diagram illustrating a controller 200 for making a power converter 100 start up normally according to a first embodiment of the present invention, wherein the controller 200 includes a detection circuit 202, an upper-bridge power supply pre-charge circuit 204, a driving signal generation circuit 206, a frequency controller 208 and a clamping circuit 210, the detection circuit 202 includes a time controller 2022 and a voltage level detector 2024, and coupling relationships between the detection circuit 202, the upper-bridge power supply pre-charge circuit 204, the driving signal generation circuit 206, the frequency controller 208, the clamping circuit 210, the time controller 2022 and the voltage level detector 2024 can be referred to FIG. 1, so further description thereof is omitted for simplicity. In addition, as shown in FIG. 1, the controller 200 is installed at a primary side PRI of the power converter 100. In addition, the power converter 100 is an inductor-inductor-capacitor (LLC) half-bridge resonant power converter, ground potential GND1 of the primary side PRI of the power converter 100 is different from ground potential GND2 of a secondary side SEC of the power converter 100, and the primary side PRI of the power converter 100 receives an input voltage VIN generated by a rectifier. In addition, in another embodiment of the present invention, the controller 200 can also be applied to the power converter 100 which is an asymmetrical half-bridge (AHB) flyback power converter. In addition, as shown in FIG. 1, the present invention is not limited to the controller 200 only including the detection circuit 202, the upper-bridge power supply pre-charge circuit 204, the driving signal generation circuit 206, the frequency controller 208 and the clamping circuit 210. That is to say, the controller 200 can also include other functional circuits (not shown in FIG. 1). In addition, as shown in FIG. 1, VO is an output voltage of the secondary side SEC of the power converter 100.

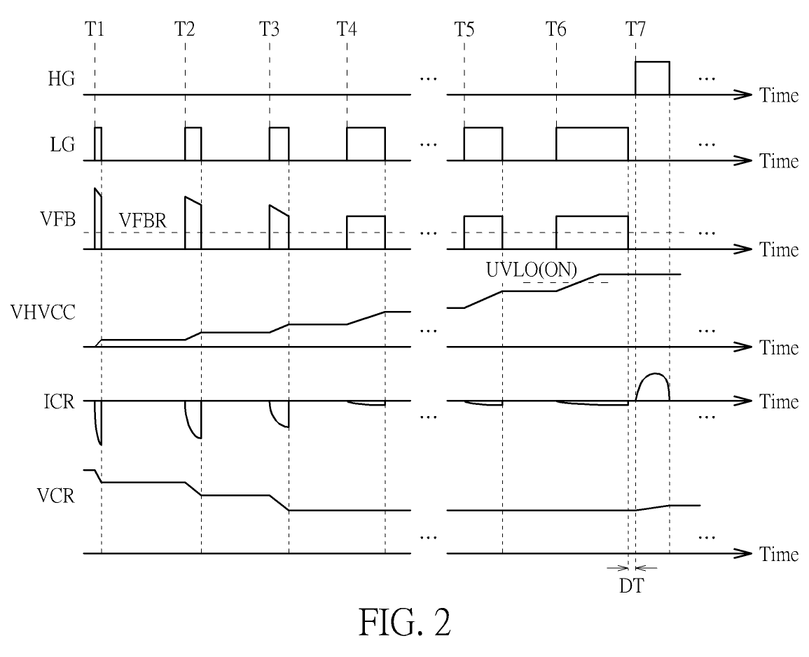

Next, please simultaneously refer to FIG. 1 and FIG. 2. As shown in FIG. 2, at a time T1, the power converter 100 starts up, first the upper-bridge power supply pre-charge circuit 204, a lower-bridge voltage level converter 2002 and a lower-bridge gate driver 2004 generate a lower-bridge switch driving signal LG to a lower-bridge switch 102 installed at the primary side PRI of the power converter 100, wherein a lower-bridge turning-on time LGOT of the lower-bridge switch driving signal LG has a minimum turning-on time, and the minimum turning-on time can make the lower-bridge switch 102 fully turned on. Because the lower-bridge switch 102 is conducted according to the lower-bridge switch driving signal LG, a power supply voltage VCC can start to charge an upper-bridge power supply storage capacitor CHVCC through a charging path 104, resulting in an upper-bridge power supply voltage VHVCC on the upper-bridge power supply storage capacitor CHVCC starting to be increased. In addition, waveforms of a resonant capacitor voltage VCR on a resonant capacitor 106 coupled to the lower-bridge switch 102 and a resonant capacitor current ICR flowing through the lower-bridge switch 102 can be referred to FIG. 2, wherein the resonant capacitor voltage VCR relates to the resonant capacitor current ICR. In addition, as shown in FIG. 1, the lower-bridge switch 102 and the resonant capacitor 106 are also installed at the primary side PRI of the power converter 100. In addition, as shown in FIG. 1, when the lower-bridge switch 102 is conducted, because an auxiliary winding voltage VAUX corresponding to the resonant capacitor voltage VCR can be generated through an auxiliary winding 108 and a primary-side winding 110 of the primary side PRI of the power converter 100 and the resonant capacitor voltage VCR, and a feedback voltage VFB can be generated by voltage dividing of the auxiliary winding voltage VAUX, the feedback voltage VFB relates to the resonant capacitor voltage VCR and a turning-on time of the feedback voltage VFB is equal to the lower-bridge turning-on time LGOT of the lower-bridge switch driving signal LG, wherein the voltage level detector 2024 can detect a feedback peak voltage VFBM of the feedback voltage VFB, and the time controller 2022 receives the feedback voltage VFB from outside of the controller 200 through a feedback pin FB of the controller 200. As shown in FIG. 2, at a time T2 and a time T3, because the upper-bridge power supply voltage VHVCC is not yet greater than a turning-on reference voltage UVLO(ON), the time controller 2022 can gradually increase the lower-bridge turning-on time LGOT of the lower-bridge switch driving signal LG according to the feedback voltage VFB during the power converter 100 starting up, wherein the upper-bridge power supply pre-charge circuit 204, the lower-bridge voltage level converter 2002 and the lower-bridge gate driver 2004 can generate the lower-bridge switch driving signal LG according to the lower-bridge turning-on time LGOT of the lower-bridge switch driving signal LG. In addition, as shown in FIG. 2, between the time T1 and the time T3, whenever the lower-bridge switch 102 is conducted, because the primary side PRI of the power converter 100 can transfer power to the secondary side SEC of the power converter 100 through the primary-side winding 110 and secondary-side windings 112, 114, the resonant capacitor voltage VCR and the resonant capacitor current ICR will be gradually decreased, resulting in the feedback voltage VFB being also gradually decreased. In addition, in another embodiment of the present invention, during the power converter 100 starting up, the time controller 2022 adjusts the lower-bridge turning-on time LGOT of the lower-bridge switch driving signal LG according to the feedback voltage VFB. That is to say, during the power converter 100 starting up, the time controller 2022 can increase or decrease the lower-bridge turning-on time LGOT of the lower-bridge switch driving signal LG according to variation of the feedback peak voltage VFBM of the feedback voltage VFB. As shown in FIG. 2, between a time T4 and a time T5, if the feedback peak voltage VFBM of the feedback voltage VFB continuously maintains at a stable value within a predetermined number cycles (that is, a first predetermined condition recited by the claim 1), meanwhile although the feedback peak voltage VFBM of the feedback voltage VFB is not less than a reference voltage VFBR, that the feedback peak voltage VFBM of the feedback voltage VFB continuously maintains at the stable value within the predetermined number cycles means that the resonant capacitor current ICR has no too high risk, so at a time T6, the time controller 2022 can increase the lower-bridge turning-on time LGOT of the lower-bridge switch driving signal LG to a maximum turning-on time to ensure that the upper-bridge power supply voltage VHVCC is greater than a turning-on reference voltage UVLO(ON) to make an upper-bridge switch 116 installed at the primary side PRI of the power converter 100 turned on correctly, wherein the predetermined number can be determined by actual design requirements, and the upper-bridge power supply pre-charge circuit 204, the lower-bridge voltage level converter 2002 and the lower-bridge gate driver 2004 stop generating the lower-bridge switch driving signal LG and the upper-bridge power supply pre-charge circuit 204 transmits a stop signal SS to the driving signal generation circuit 206 after the upper-bridge power supply voltage VHVCC is greater than the turning-on reference voltage UVLO(ON). Therefore, after the upper-bridge power supply pre-charge circuit 204 transmits the stop signal SS to the driving signal generation circuit 206, as shown in FIG. 2, at a time T7, the driving signal generation circuit 206, an upper-bridge voltage level converter 2006 and an upper-bridge gate driver 2008 generate an upper-bridge switch driving signal HG to the upper-bridge switch 116 of the primary side PRI of the power converter 100, wherein a dead time DT exists between the upper-bridge switch driving signal HG and the lower-bridge switch driving signal LG, the dead time DT can prevent the upper-bridge switch driving signal HG and the lower-bridge switch driving signal LG from being enabled simultaneously, and the resonant capacitor voltage VCR and the resonant capacitor current ICR corresponding to the upper-bridge switch driving signal HG can be referred to FIG. 2. After the driving signal generation circuit 206, the upper-bridge voltage level converter 2006 and the upper-bridge gate driver 2008 generate the upper-bridge switch driving signal HG, the driving signal generation circuit 206, the lower-bridge voltage level converter 2002 and the lower-bridge gate driver 2004 generate the lower-bridge switch driving signal LG to the lower-bridge switch 102 and the driving signal generation circuit 206, the upper-bridge voltage level converter 2006 and the upper-bridge gate driver 2008 generate the upper-bridge switch driving signal HG to the upper-bridge switch 116 alternately to make the power converter 100 operate normally, wherein the lower-bridge switch 102 is turned on according to the lower-bridge switch driving signal LG and the upper-bridge switch 116 is turned on according to the upper-bridge switch driving signal HG. In addition, the frequency controller 208 is used for generating a controller clock CLK with a predetermined frequency to the time controller 2022 and the driving signal generation circuit 206, wherein the controller clock CLK can make the lower-bridge switch driving signal LG and the upper-bridge switch driving signal HG have the predetermined frequency, and the lower-bridge switch driving signal LG and the upper-bridge switch driving signal HG are pulse-width modulation (PWM) signals. In addition, as shown in FIG. 1, the clamping circuit 210 is used for clamping the feedback voltage VFB. However, in another embodiment of the present invention, the controller 200 does not include the clamping circuit 210. In addition, as shown in FIG. 1, HVCC is an upper-bridge power supply voltage of the upper-bridge gate driver 2008 and HGND is upper-bridge ground potential of the upper-bridge gate driver 2008.

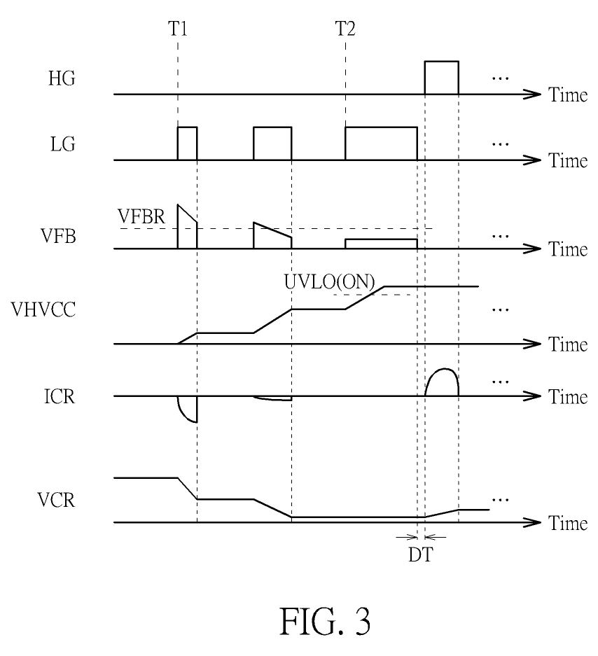

Next, please refer to FIG. 3. FIG. 3 is a waveform timing diagram illustrating the upper-bridge switch driving signal HG, the lower-bridge switch driving signal LG, the feedback voltage VFB, the upper-bridge power supply voltage VHVCC on the upper-bridge power supply storage capacitor CHVCC, the resonant capacitor voltage VCR on the resonant capacitor 106 and the resonant capacitor current ICR flowing through the lower-bridge switch 102 according to another embodiment of the present invention. As shown in FIG. 3, at the time T1, the power converter 100 starts up, the upper-bridge power supply pre-charge circuit 204, the lower-bridge voltage level converter 2002 and the lower-bridge gate driver 2004 first generate the lower-bridge switch driving signal LG to the lower-bridge switch 102. Afterward, the feedback voltage VFB is gradually reduced until it is lower than the reference voltage VFBR at the time T2. Because the feedback voltage VFB relates to the resonant capacitor voltage VCR and the resonant capacitor voltage VCR relates to the resonant capacitor current ICR, meanwhile (i.e. the time T2) it is means that the resonant capacitor current ICR has no too high risk. Therefore, at the time T2, the time controller 2022 can increase the lower-bridge turning-on time LGOT of the lower-bridge switch driving signal LG to the maximum turning-on time to ensure that the upper-bridge power supply voltage VHVCC is greater than the turning-on reference voltage UVLO(ON) to make the upper-bridge switch 116 turned on correctly, wherein the upper-bridge power supply pre-charge circuit 204, the lower-bridge voltage level converter 2002 and the lower-bridge gate driver 2004 stop generating the lower-bridge switch driving signal LG and the upper-bridge power supply pre-charge circuit 204 transmits the stop signal SS to the driving signal generation circuit 206 after the upper-bridge power supply voltage VHVCC is greater than the turning-on reference voltage UVLO(ON). Therefore, after the upper-bridge power supply pre-charge circuit 204 transmits the stop signal SS to the driving signal generation circuit 206, as shown in FIG. 3, at the time T3, the driving signal generation circuit 206, the upper-bridge voltage level converter 2006 and the upper-bridge gate driver 2008 generate the upper-bridge switch driving signal HG to the upper-bridge switch 116. In addition, after the driving signal generation circuit 206, the upper-bridge voltage level converter 2006 and the upper-bridge gate driver 2008 generate the upper-bridge switch driving signal HG, the driving signal generation circuit 206, the lower-bridge voltage level converter 2002 and the lower-bridge gate driver 2004 generate the lower-bridge switch driving signal LG to the lower-bridge switch 102 and the driving signal generation circuit 206, the upper-bridge voltage level converter 2006 and the upper-bridge gate driver 2008 generate the upper-bridge switch driving signal HG to the upper-bridge switch 116 alternately to make the power converter 100 operate normally. In addition, the upper-bridge power supply voltage VHVCC, the resonant capacitor voltage VCR and the resonant capacitor current ICR corresponding to the lower-bridge switch driving signal LG and the upper-bridge power supply voltage VHVCC, the resonant capacitor voltage VCR and the resonant capacitor current ICR corresponding to the upper-bridge switch driving signal HG can be referred to FIG. 3, so further description thereof is omitted for simplicity.

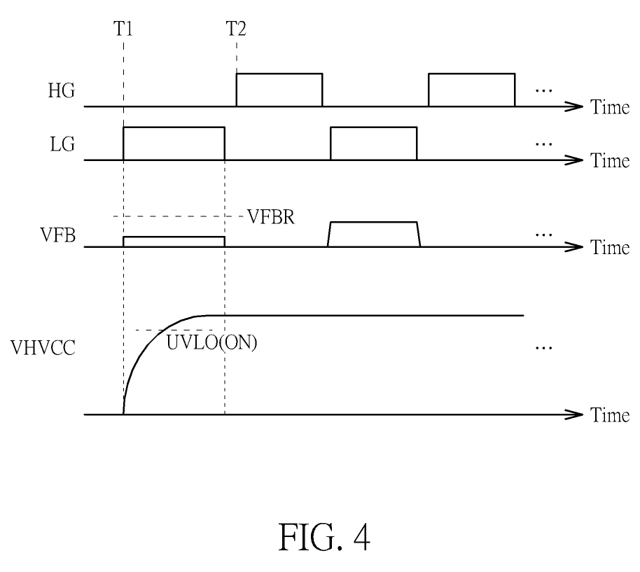

Next, please refer to FIG. 4. FIG. 4 is a waveform timing diagram illustrating the upper-bridge switch driving signal HG, the lower-bridge switch driving signal LG, the feedback voltage VFB and the upper-bridge power supply voltage VHVCC on the upper-bridge power supply storage capacitor CHVCC if the feedback voltage VFB has been lower than the reference voltage VFBR when the power converter 100 starts up. As shown in FIG. 4, at the time T1, the power converter 100 starts up, meanwhile because the feedback voltage VFB has been lower than the reference voltage VFBR, it means that the resonant capacitor current ICR has no too high risk. Therefore, at the time T1, the time controller 2022 can increase the lower-bridge turning-on time LGOT of the lower-bridge switch driving signal LG to the maximum turning-on time to ensure that the upper-bridge power supply voltage VHVCC is greater than the turning-on reference voltage UVLO(ON) to make the upper-bridge switch 116 turned on correctly, wherein the upper-bridge power supply pre-charge circuit 204, the lower-bridge voltage level converter 2002 and the lower-bridge gate driver 2004 stop generating the lower-bridge switch driving signal LG and the upper-bridge power supply pre-charge circuit 204 transmits the stop signal SS to the driving signal generation circuit 206 after the upper-bridge power supply voltage VHVCC is greater than the turning-on reference voltage UVLO(ON). Therefore, after the upper-bridge power supply pre-charge circuit 204 transmits the stop signal SS to the driving signal generation circuit 206, as shown in FIG. 4, at the time T2, the driving signal generation circuit 206, the lower-bridge voltage level converter 2002 and the lower-bridge gate driver 2004 generate the lower-bridge switch driving signal LG to the lower-bridge switch 102 and the driving signal generation circuit 206, the upper-bridge voltage level converter 2006 and the upper-bridge gate driver 2008 generate the upper-bridge switch driving signal HG to the upper-bridge switch 116 alternately to make the power converter 100 operate normally. In addition, the upper-bridge power supply voltage VHVCC corresponding to the lower-bridge switch driving signal LG and the upper-bridge switch driving signal HG can be referred to FIG. 4, so further description thereof is omitted for simplicity.

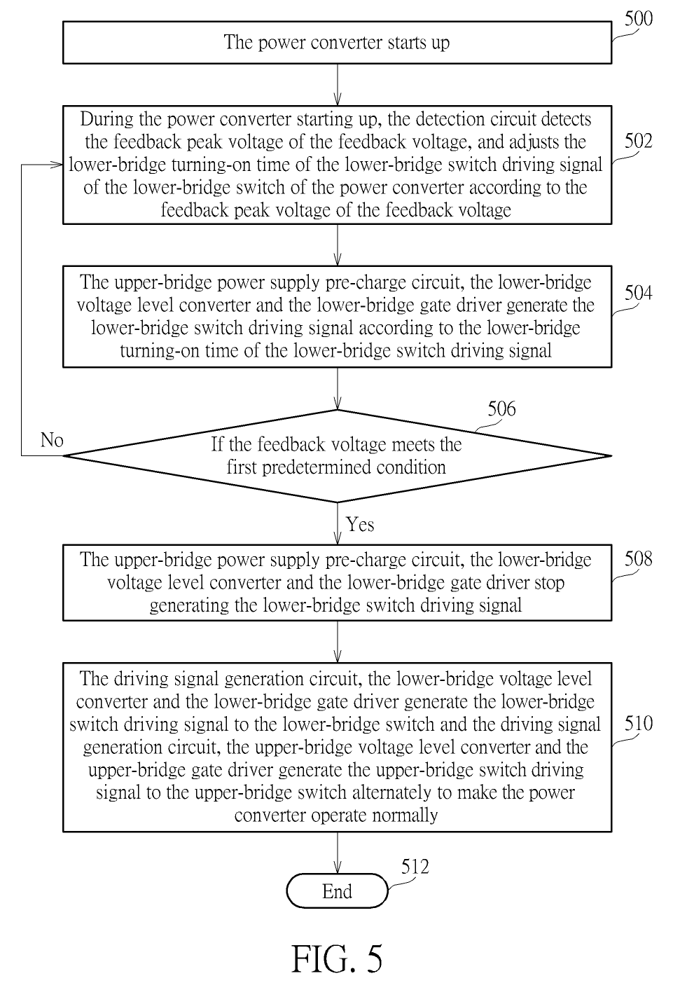

In addition, please refer to FIG. 1, FIG. 2, FIG. 3, FIG. 4, FIG. 5, wherein FIG. 5 is a flowchart illustrating an operational method of a controller which makes a power converter start up normally according to a second embodiment of the present invention. The operational method in FIG. 5 is illustrated by using the power converter 100 and the controller 200 in FIG. 1. Detailed Steps are as follows:

Step 500: The power converter 100 starts up.

Step 502: During the power converter 100 starting up, the detection circuit 202 detects the feedback peak voltage VFBM of the feedback voltage VFB, and adjusts the lower-bridge turning-on time LGOT of the lower-bridge switch driving signal LG of the lower-bridge switch 102 of the power converter 100 according to the feedback peak voltage VFBM of the feedback voltage VFB.

Step 504: The upper-bridge power supply pre-charge circuit 204, the lower-bridge voltage level converter 2002 and the lower-bridge gate driver 2004 generate the lower-bridge switch driving signal LG according to the lower-bridge turning-on time LGOT of the lower-bridge switch driving signal LG.

Step 506: If the feedback voltage VFB meets the first predetermined condition; if yes, go to Step 508; if no, go to Step 502.

Step 508: The upper-bridge power supply pre-charge circuit 204, the lower-bridge voltage level converter 2002 and the lower-bridge gate driver 2004 stop generating the lower-bridge switch driving signal LG.

Step 510: The driving signal generation circuit 206, the lower-bridge voltage level converter 2002 and the lower-bridge gate driver 2004 generate the lower-bridge switch driving signal LG to the lower-bridge switch 102 and the driving signal generation circuit 206, the upper-bridge voltage level converter 2006 and the upper-bridge gate driver 2008 generate the upper-bridge switch driving signal HG to the upper-bridge switch 116 alternately to make the power converter 100 operate normally.

Step 512: End.

In Step 502, as shown in FIG. 2, at the time T1, the power converter 100 starts up, first the upper-bridge power supply pre-charge circuit 204, the lower-bridge voltage level converter 2002 and the lower-bridge gate driver 2004 generate the lower-bridge switch driving signal LG to the lower-bridge switch 102 installed at the primary side PRI of the power converter 100, wherein the lower-bridge turning-on time LGOT of the lower-bridge switch driving signal LG has the minimum turning-on time, and the minimum turning-on time can make the lower-bridge switch 102 fully turned on. In addition, as shown in FIG. 1, when the lower-bridge switch 102 is conducted, the voltage level detector 2024 within the detection circuit 202 can detect the feedback peak voltage VFBM of the feedback voltage VFB, and the time controller 2022 receives the feedback voltage VFB from outside of the controller 200 through the feedback pin FB of the controller 200. As shown in FIG. 2, at the time T2 and the time T3, because the upper-bridge power supply voltage VHVCC is not yet greater than the turning-on reference voltage UVLO(ON), the time controller 2022 within the detection circuit 202 can gradually increase the lower-bridge turning-on time LGOT of the lower-bridge switch driving signal LG according to the feedback voltage VFB during the power converter 100 starting up. In addition, in another embodiment of the present invention, the time controller 2022 adjusts the lower-bridge turning-on time LGOT of the lower-bridge switch driving signal LG according to the feedback voltage VFB during the power converter 100 starting up. That is to say, the time controller 2022 can increase or decrease the lower-bridge turning-on time LGOT of the lower-bridge switch driving signal LG according to variation of the feedback peak voltage VFBM of the feedback voltage VFB during the power converter 100 starting up.

In Step 504, the upper-bridge power supply pre-charge circuit 204, the lower-bridge voltage level converter 2002 and the lower-bridge gate driver 2004 can generate the lower-bridge switch driving signal LG according to the lower-bridge turning-on time LGOT of the lower-bridge switch driving signal LG. In addition, as shown in FIG. 2, between the time T1 and the time T3, whenever the lower-bridge switch 102 is conducted, because the primary side PRI of the power converter 100 can transfer power to the secondary side SEC of the power converter 100 through the primary-side winding 110 and the secondary-side windings 112, 114, the resonant capacitor voltage VCR and the resonant capacitor current ICR will be gradually decreased, resulting in the feedback voltage VFB being also gradually decreased.

In Step 506 and Step 508, as shown in FIG. 2, between the time T4 and the time T5, if the feedback peak voltage VFBM of the feedback voltage VFB continuously maintains at the stable value within the predetermined number cycles (i.e. the first predetermined condition), meanwhile although the feedback peak voltage VFBM of the feedback voltage VFB is not less than the reference voltage VFBR, that the feedback peak voltage VFBM of the feedback voltage VFB continuously maintains at the stable value within the predetermined number cycles means that the resonant capacitor current ICR has no too high risk, so at the time T6, the time controller 2022 can increase the lower-bridge turning-on time LGOT of the lower-bridge switch driving signal LG to the maximum turning-on time to ensure that the upper-bridge power supply voltage VHVCC is greater than the turning-on reference voltage UVLO(ON) to make the upper-bridge switch 116 installed at the primary side PRI of the power converter 100 turned on correctly. The upper-bridge power supply pre-charge circuit 204, the lower-bridge voltage level converter 2002 and the lower-bridge gate driver 2004 stop generating the lower-bridge switch driving signal LG and the upper-bridge power supply pre-charge circuit 204 transmits the stop signal SS to the driving signal generation circuit 206 after the upper-bridge power supply voltage VHVCC is greater than the turning-on reference voltage UVLO(ON).

In Step 510, after the upper-bridge power supply pre-charge circuit 204 transmits the stop signal SS to the driving signal generation circuit 206, as shown in FIG. 2, at the time T7, the driving signal generation circuit 206, the upper-bridge voltage level converter 2006 and the upper-bridge gate driver 2008 generate the upper-bridge switch driving signal HG to the upper-bridge switch 116. After the driving signal generation circuit 206, the upper-bridge voltage level converter 2006 and the upper-bridge gate driver 2008 generate the upper-bridge switch driving signal HG, the driving signal generation circuit 206, the lower-bridge voltage level converter 2002 and the lower-bridge gate driver 2004 generate the lower-bridge switch driving signal LG to the lower-bridge switch 102 and the driving signal generation circuit 206, the upper-bridge voltage level converter 2006 and the upper-bridge gate driver 2008 generate the upper-bridge switch driving signal HG to the upper-bridge switch 116 alternately to make the power converter 100 operate normally.

In addition, please refer to FIG. 3. In Step 506 and Step 508, as shown in FIG. 3, the feedback voltage VFB is gradually reduced until it is lower than the reference voltage VFBR at the time T2 (i.e. the first predetermined condition). Because the feedback voltage VFB relates to the resonant capacitor voltage VCR and the resonant capacitor voltage VCR relates to the resonant capacitor current ICR, meanwhile (i.e. the time T2) it is means that the resonant capacitor current ICR has no too high risk. Therefore, at the time T2, the time controller 2022 can increase the lower-bridge turning-on time LGOT of the lower-bridge switch driving signal LG to the maximum turning-on time to ensure that the upper-bridge power supply voltage VHVCC is greater than the turning-on reference voltage UVLO(ON) to make the upper-bridge switch 116 turned on correctly, wherein the upper-bridge power supply pre-charge circuit 204, the lower-bridge voltage level converter 2002 and the lower-bridge gate driver 2004 stop generating the lower-bridge switch driving signal LG and the upper-bridge power supply pre-charge circuit 204 transmits the stop signal SS to the driving signal generation circuit 206 after the upper-bridge power supply voltage VHVCC is greater than the turning-on reference voltage UVLO(ON).

In Step 510, after the upper-bridge power supply pre-charge circuit 204 transmits the stop signal SS to the driving signal generation circuit 206, as shown in FIG. 3, at the time T3, the driving signal generation circuit 206, the upper-bridge voltage level converter 2006 and the upper-bridge gate driver 2008 generate the upper-bridge switch driving signal HG to the upper-bridge switch 116. In addition, after the driving signal generation circuit 206, the upper-bridge voltage level converter 2006 and the upper-bridge gate driver 2008 generate the upper-bridge switch driving signal HG, the driving signal generation circuit 206, the lower-bridge voltage level converter 2002 and the lower-bridge gate driver 2004 generate the lower-bridge switch driving signal LG to the lower-bridge switch 102 and the driving signal generation circuit 206, the upper-bridge voltage level converter 2006 and the upper-bridge gate driver 2008 generate the upper-bridge switch driving signal HG to the upper-bridge switch 116 alternately to make the power converter 100 operate normally.

In addition, please refer to FIG. 4. In Step 502, Step 504 and Step 506, as shown in FIG. 4, at the time T1, the power converter 100 starts up, meanwhile because the feedback voltage VFB has been lower than the reference voltage VFBR, it means that the resonant capacitor current ICR has no too high risk. Therefore, at the time T1, the time controller 2022 can increase the lower-bridge turning-on time LGOT of the lower-bridge switch driving signal LG to the maximum turning-on time to ensure that the upper-bridge power supply voltage VHVCC is greater than the turning-on reference voltage UVLO(ON) to make the upper-bridge switch 116 turned on correctly.

In Step 508 and Step 510, the upper-bridge power supply pre-charge circuit 204, the lower-bridge voltage level converter 2002 and the lower-bridge gate driver 2004 stop generating the lower-bridge switch driving signal LG and the upper-bridge power supply pre-charge circuit 204 transmits the stop signal SS to the driving signal generation circuit 206 after the upper-bridge power supply voltage VHVCC is greater than the turning-on reference voltage UVLO(ON). Therefore, after the upper-bridge power supply pre-charge circuit 204 transmits the stop signal SS to the driving signal generation circuit 206, as shown in FIG. 4, at the time T2, the driving signal generation circuit 206, the lower-bridge voltage level converter 2002 and the lower-bridge gate driver 2004 generate the lower-bridge switch driving signal LG to the lower-bridge switch 102 and the driving signal generation circuit 206, the upper-bridge voltage level converter 2006 and the upper-bridge gate driver 2008 generate the upper-bridge switch driving signal HG to the upper-bridge switch 116 alternately to make the power converter 100 operate normally.

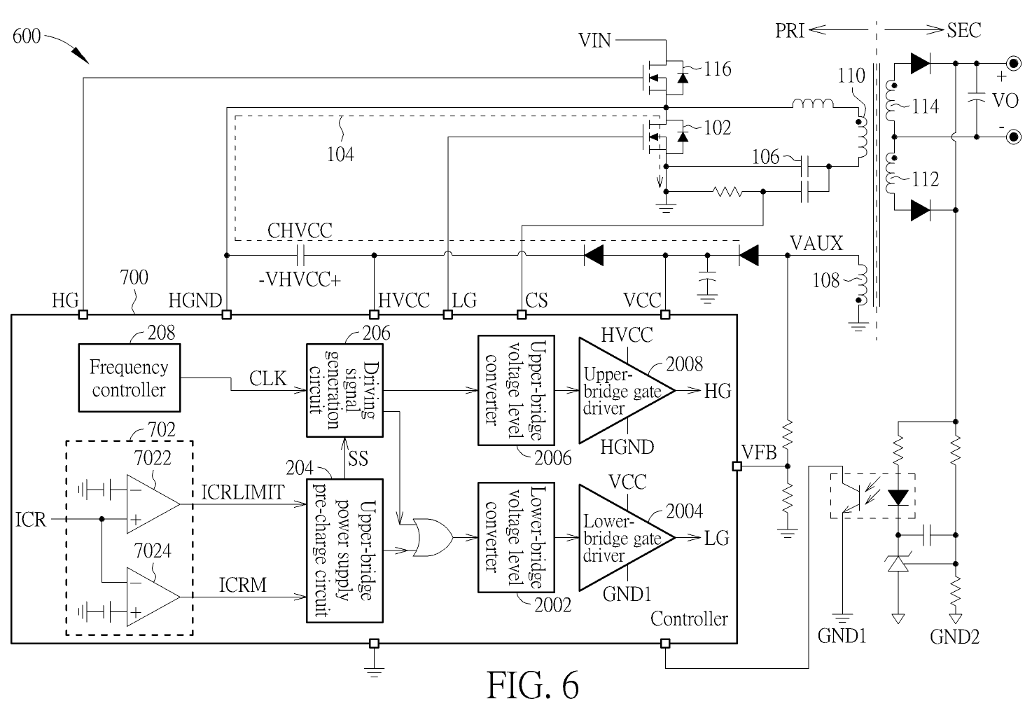

Next, please refer to FIG. 6. FIG. 6 is a diagram illustrating a controller 700 for making a power converter 600 start up normally according to a third embodiment of the present invention, wherein the controller 700 includes a detection circuit 702, the upper-bridge power supply pre-charge circuit 204, the driving signal generation circuit 206 and the frequency controller 208, the detection circuit 702 includes a first comparator 7022 and a second comparator 7024, and coupling relationships between the detection circuit 702, the upper-bridge power supply pre-charge circuit 204, the driving signal generation circuit 206, the frequency controller 208, the first comparator 7022 and the second comparator 7024 can be referred to FIG. 6, so further description thereof is omitted for simplicity. In addition, as shown in FIG. 1, the controller 700 is installed at a primary side PRI of the power converter 600. In addition, the power converter 600 which is an inductor-inductor-capacitor (LLC) half-bridge resonant power converter or an asymmetrical half-bridge (AHB) flyback power converter.

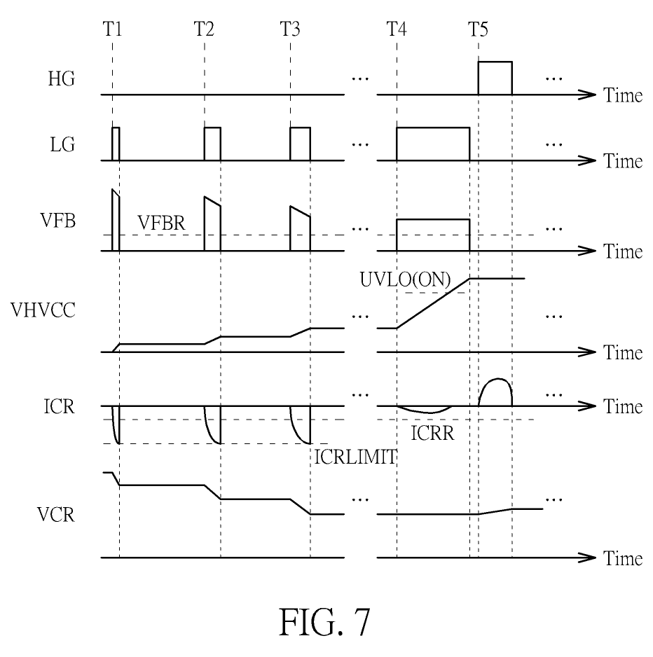

Next, please simultaneously refer to FIG. 6 and FIG. 7. As shown in FIG. 7, at a time T1, the power converter 600 starts up, first the upper-bridge power supply pre-charge circuit 204, the lower-bridge voltage level converter 2002 and the lower-bridge gate driver 2004 generate the lower-bridge switch driving signal LG to the lower-bridge switch 102 installed at the primary side PRI of the power converter 600, wherein the lower-bridge turning-on time LGOT of the lower-bridge switch driving signal LG has the minimum turning-on time, and the minimum turning-on time can make the lower-bridge switch 102 fully turned on. Because the lower-bridge switch 102 is conducted, the power supply voltage VCC can start to charge the upper-bridge power supply storage capacitor CHVCC through the charging path 104, resulting in the upper-bridge power supply voltage VHVCC on the upper-bridge power supply storage capacitor CHVCC starting to be increased. In addition, waveforms of the resonant capacitor voltage VCR on the resonant capacitor 106 coupled to the lower-bridge switch 102 and the resonant capacitor current ICR flowing through the lower-bridge switch 102 can be referred to FIG. 7, wherein the resonant capacitor voltage VCR relates to the resonant capacitor current ICR. In addition, when the lower-bridge switch 102 is conducted, because the auxiliary winding voltage VAUX corresponding to the resonant capacitor voltage VCR can be generated through the auxiliary winding 108 and the primary-side winding 110 of the primary side PRI of the power converter 600 and the resonant capacitor voltage VCR, and the feedback voltage VFB can be generated by voltage dividing of the auxiliary winding voltage VAUX, the feedback voltage VFB relates to the resonant capacitor voltage VCR, and the turning-on time of the feedback voltage VFB is equal to the lower-bridge turning-on time LGOT of the lower-bridge switch driving signal LG, wherein the detection circuit 702 receives the resonant capacitor current ICR from outside of the controller 700 through a current sensing pin CS of the controller 700 and detects a peak value ICRM of the resonant capacitor current ICR. When the peak value ICRM of the resonant capacitor current ICR is greater than a current limit value ICRLIMIT, the first comparator 7022 outputs the current limit value ICRLIMIT to protect the lower-bridge switch 102, and when the peak value ICRM of the resonant capacitor current ICR is less than less than the current limit value ICRLIMI, the second comparator 7024 outputs the peak value ICRM of the resonant capacitor current ICR.

As shown in FIG. 7, at a time T2 and a time T3, because the peak value ICRM of the resonant capacitor current ICR is greater than the current limit value ICRLIMIT, the upper-bridge power supply pre-charge circuit 204 can gradually increase the lower-bridge turning-on time LGOT of the lower-bridge switch driving signal LG according to the current limit value ICRLIMIT during the power converter 600 starting up, wherein the upper-bridge power supply pre-charge circuit 204, the lower-bridge voltage level converter 2002 and the lower-bridge gate driver 2004 can generate the lower-bridge switch driving signal LG according to the current limit value ICRLIMIT. In addition, in another embodiment of the present invention, the upper-bridge power supply pre-charge circuit 204 adjusts the lower-bridge turning-on time LGOT of the lower-bridge switch driving signal LG according to the current limit value ICRLIMIT during the power converter 600 starting up. As shown in FIG. 7, after a time T4, the peak value ICRM of the resonant capacitor current ICR is less than a reference current ICRR, meanwhile it means that the resonant capacitor current ICR has no too high risk, so the upper-bridge power supply pre-charge circuit 204 can increase the lower-bridge turning-on time LGOT of the lower-bridge switch driving signal LG to the maximum turning-on time to ensure that the upper-bridge power supply voltage VHVCC is greater than the turning-on reference voltage UVLO(ON) to make the upper-bridge switch 116 turned on correctly, wherein the upper-bridge power supply pre-charge circuit 204, the lower-bridge voltage level converter 2002 and the lower-bridge gate driver 2004 stop generating the lower-bridge switch driving signal LG and the upper-bridge power supply pre-charge circuit 204 transmits the stop signal SS to the driving signal generation circuit 206 after the upper-bridge power supply voltage VHVCC is greater than the turning-on reference voltage UVLO(ON). Therefore, after the upper-bridge power supply pre-charge circuit 204 transmits the stop signal SS to the driving signal generation circuit 206, as shown in FIG. 7, at a time T5, the driving signal generation circuit 206, the upper-bridge voltage level converter 2006 and the upper-bridge gate driver 2008 generate the upper-bridge switch driving signal HG to the upper-bridge switch 116. After the driving signal generation circuit 206, the upper-bridge voltage level converter 2006 and the upper-bridge gate driver 2008 generate the upper-bridge switch driving signal HG, the driving signal generation circuit 206, the lower-bridge voltage level converter 2002 and the lower-bridge gate driver 2004 generate the lower-bridge switch driving signal LG to the lower-bridge switch 102 and the driving signal generation circuit 206, the upper-bridge voltage level converter 2006 and the upper-bridge gate driver 2008 generate the upper-bridge switch driving signal HG to the upper-bridge switch 116 alternately to make the power converter 600 operate normally. In addition, the upper-bridge power supply voltage VHVCC and the resonant capacitor voltage VCR related to the resonant capacitor current ICR corresponding to the lower-bridge switch driving signal LG, and the upper-bridge power supply voltage VHVCC and the resonant capacitor voltage VCR related to the resonant capacitor current ICR corresponding to the upper-bridge switch driving signal HG can be referred to FIG. 7, so further description thereof is omitted for simplicity.

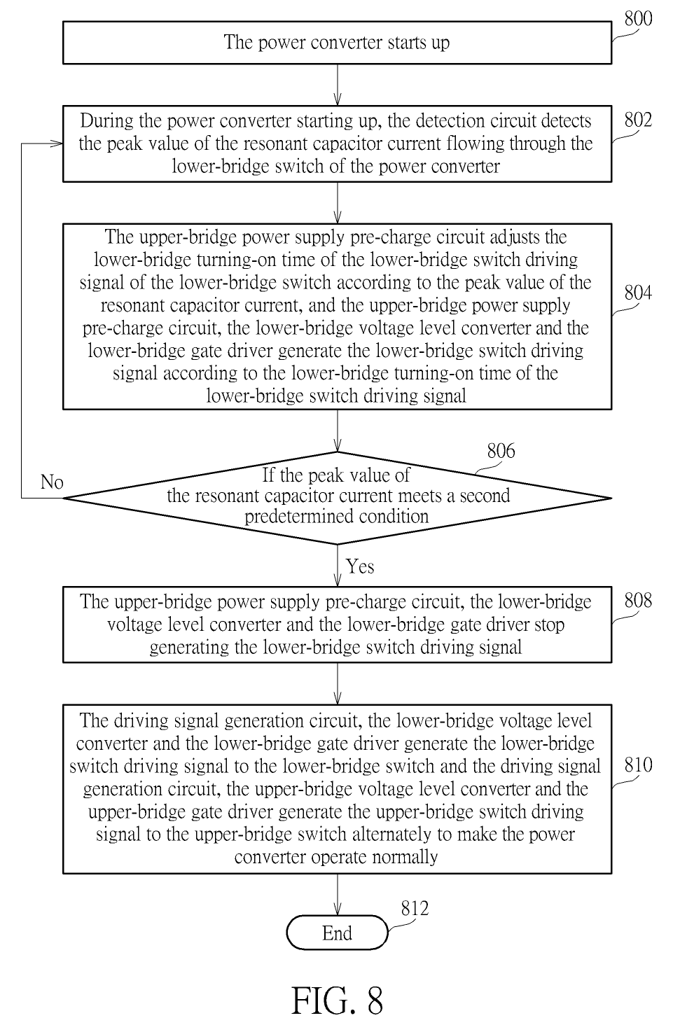

In addition, please refer to FIG. 6, FIG. 7, FIG. 8, wherein FIG. 8 is a flowchart illustrating an operational method of a controller which makes a power converter start up normally according to a fourth embodiment of the present invention. The operational method in FIG. 8 is illustrated by using the power converter 600 and the controller 700 in FIG. 6. Detailed Steps are as follows:

Step 800: The power converter 600 starts up.

Step 802: During the power converter 600 starting up, the detection circuit 702 detects the peak value ICRM of the resonant capacitor current ICR flowing through the lower-bridge switch 102 of the power converter 600.

Step 804: The upper-bridge power supply pre-charge circuit 204 adjusts the lower-bridge turning-on time LGOT of the lower-bridge switch driving signal LG of the lower-bridge switch 102 according to the peak value ICRM of the resonant capacitor current ICR, and the upper-bridge power supply pre-charge circuit 204, the lower-bridge voltage level converter 2002 and the lower-bridge gate driver 2004 generate the lower-bridge switch driving signal LG according to the lower-bridge turning-on time LGOT of the lower-bridge switch driving signal LG.

Step 806: If the peak value ICRM of the resonant capacitor current ICR meets a second predetermined condition; if yes, go to Step 808; if no, go to Step 802.

Step 808: The upper-bridge power supply pre-charge circuit 204, the lower-bridge voltage level converter 2002 and the lower-bridge gate driver 2004 stop generating the lower-bridge switch driving signal LG.

Step 810: The driving signal generation circuit 206, the lower-bridge voltage level converter 2002 and the lower-bridge gate driver 2004 generate the lower-bridge switch driving signal LG to the lower-bridge switch 102 and the driving signal generation circuit 206, the upper-bridge voltage level converter 2006 and the upper-bridge gate driver 2008 generate the upper-bridge switch driving signal HG to the upper-bridge switch 116 alternately to make the power converter 100 operate normally.

Step 812: End.

In Step 802, as shown in FIG. 7, at the time T1, the power converter 600 starts up, first the upper-bridge power supply pre-charge circuit 204, the lower-bridge voltage level converter 2002 and the lower-bridge gate driver 2004 generate the lower-bridge switch driving signal LG to the lower-bridge switch 102 installed at the primary side PRI of the power converter 600, wherein the detection circuit 702 receives the resonant capacitor current ICR from outside of the controller 700 through the current sensing pin CS of the controller 700 and detects the peak value ICRM of the resonant capacitor current ICR.

When the peak value ICRM of the resonant capacitor current ICR is greater than the current limit value ICRLIMIT, the first comparator 7022 outputs the current limit value ICRLIMIT to protect the lower-bridge switch 102, and when the peak value ICRM of the resonant capacitor current ICR is less than the current limit value ICRLIMI, the second comparator 7024 outputs the peak value ICRM of the resonant capacitor current ICR. Therefore, in Step 804, as shown in FIG. 7, at the time T2 and the time T3, because the peak value ICRM of the resonant capacitor current ICR is greater than the current limit value ICRLIMIT, the upper-bridge power supply pre-charge circuit 204 can gradually increase the lower-bridge turning-on time LGOT of the lower-bridge switch driving signal LG according to the current limit value ICRLIMIT during the power converter 600 starting up, wherein the upper-bridge power supply pre-charge circuit 204, the lower-bridge voltage level converter 2002 and the lower-bridge gate driver 2004 can generate the lower-bridge switch driving signal LG according to the current limit value ICRLIMIT. In addition, in another embodiment of the present invention, the upper-bridge power supply pre-charge circuit 204 adjusts the lower-bridge turning-on time LGOT of the lower-bridge switch driving signal LG according to the current limit value ICRLIMIT during the power converter 600 starting up.

In Step 806 and Step 808, as shown in FIG. 7, after the time T4, the peak value ICRM of the resonant capacitor current ICR is less than the reference current ICRR, meanwhile it means that the resonant capacitor current ICR has no too high risk, so the upper-bridge power supply pre-charge circuit 204 can increase the lower-bridge turning-on time LGOT of the lower-bridge switch driving signal LG to the maximum turning-on time to ensure that the upper-bridge power supply voltage VHVCC is greater than the turning-on reference voltage UVLO(ON) to make the upper-bridge switch 116 turned on correctly, wherein the upper-bridge power supply pre-charge circuit 204, the lower-bridge voltage level converter 2002 and the lower-bridge gate driver 2004 stop generating the lower-bridge switch driving signal LG and the upper-bridge power supply pre-charge circuit 204 transmits the stop signal SS to the driving signal generation circuit 206 after the upper-bridge power supply voltage VHVCC is greater than the turning-on reference voltage UVLO(ON).

In Step 810, after the upper-bridge power supply pre-charge circuit 204 transmits the stop signal SS to the driving signal generation circuit 206, as shown in FIG. 7, at the time T5, the driving signal generation circuit 206, the upper-bridge voltage level converter 2006 and the upper-bridge gate driver 2008 generate the upper-bridge switch driving signal HG to the upper-bridge switch 116. After the driving signal generation circuit 206, the upper-bridge voltage level converter 2006 and the upper-bridge gate driver 2008 generate the upper-bridge switch driving signal HG, the driving signal generation circuit 206, the lower-bridge voltage level converter 2002 and the lower-bridge gate driver 2004 generate the lower-bridge switch driving signal LG to the lower-bridge switch 102 and the driving signal generation circuit 206, the upper-bridge voltage level converter 2006 and the upper-bridge gate driver 2008 generate the upper-bridge switch driving signal HG to the upper-bridge switch 116 alternately to make the power converter 600 operate normally.

To sum up, the controller provided by the present invention and the operational method thereof during the power converter starting up, gradually increase or adjusts the lower-bridge turning-on time of the lower-bridge switch driving signal according to the feedback voltage related to the resonant capacitor current flowing through the lower-bridge switch, or gradually increase or adjusts the lower-bridge turning-on time of the lower-bridge switch driving signal directly according to the resonant capacitor current flowing through the lower-bridge switch to make the upper-bridge power supply voltage on the upper-bridge power supply storage capacitor greater than the reference voltage, thereby the power converter operating normally. Therefore, compared to the prior art, the present invention not only has lower cost, but also has lower power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controller for making a power converter start up normally, comprising:
a detection circuit for detecting a feedback voltage during the power converter starting up, and adjusting a lower-bridge turning-on time of a lower-bridge switch driving signal of a lower-bridge switch of the power converter according to the feedback voltage;
an upper-bridge power supply pre-charge circuit coupled to the detection circuit, wherein the upper-bridge power supply pre-charge circuit generates the lower-bridge switch driving signal according to the lower-bridge turning-on time, and stops generating the lower-bridge switch driving signal when the feedback voltage meets a first predetermined condition, wherein the first predetermined condition relates to a feedback peak voltage of the feedback voltage; and
a driving signal generation circuit coupled to the upper-bridge power supply pre-charge circuit for generating the lower-bridge switch driving signal to the lower-bridge switch and an upper-bridge switch driving signal to an upper-bridge switch of the power converter to make the power converter operate normally after upper-bridge power supply pre-charge circuit stops generating the lower-bridge switch driving signal.

2. The controller of claim 1, wherein the detection circuit receives the feedback voltage from outside the controller, and the first predetermined condition is that the feedback peak voltage of the feedback voltage is less than a reference voltage or the feedback peak voltage of the feedback voltage maintains at a stable value within a predetermined number cycles.

3. The controller of claim 1, wherein the lower-bridge turning-on time of the lower-bridge switch driving signal has a minimum turning-on time or a maximum turning-on time.

4. The controller of claim 1, wherein the feedback voltage relates to a resonant capacitor voltage on a resonant capacitor coupled to the lower-bridge switch and a resonant capacitor current flowing through the lower-bridge switch, and the lower-bridge switch, the resonant capacitor and the controller are installed at a primary side of the power converter.

5. The controller of claim 1, wherein the detection circuit gradually increases the lower-bridge turning-on time of the lower-bridge switch driving signal according to the feedback voltage or adjusts the lower-bridge turning-on time of the lower-bridge switch driving signal according to the feedback voltage.

6. The controller of claim 1, further comprising a frequency controller, wherein the frequency controller is used for generating a controller clock with a predetermined frequency, and the controller clock makes the lower-bridge switch driving signal and the upper-bridge switch driving signal have the predetermined frequency.

7. The controller of claim 1, wherein the power converter is an inductor-inductor-capacitor (LLC) half-bridge resonant power converter or an asymmetrical half-bridge (AHB) flyback power converter.

8. A controller for making a power converter start up normally, comprising:
a detection circuit for detecting a peak value of a resonant capacitor current flowing through a lower-bridge switch of the power converter during the power converter starting up;
an upper-bridge power supply pre-charge circuit coupled to the detection circuit, wherein the upper-bridge power supply pre-charge circuit adjusts a lower-bridge turning-on time of a lower-bridge switch driving signal of the lower-bridge switch according to the peak value of the resonant capacitor current, and the upper-bridge power supply pre-charge circuit generates the lower-bridge switch driving signal according to the lower-bridge turning-on time and stops generating the lower-bridge switch driving signal when the peak value of the resonant capacitor current meets a second predetermined condition; and
a driving signal generation circuit coupled to the upper-bridge power supply pre-charge circuit for generating the lower-bridge switch driving signal to the lower-bridge switch and an upper-bridge switch driving signal to an upper-bridge switch of the power converter to make the power converter operate normally after the upper-bridge power supply pre-charge circuit stops generating the lower-bridge switch driving signal.

9. The controller of claim 8, wherein the detection circuit receives the resonant capacitor current from outside the controller, and the second predetermined condition is that the peak value of the resonant capacitor current is less than a reference current.

10. The controller of claim 8, wherein the upper-bridge power supply pre-charge circuit gradually increases the lower-bridge turning-on time of the lower-bridge switch driving signal according to the resonant capacitor current or adjusts the lower-bridge turning-on time of the lower-bridge switch driving signal according to the resonant capacitor current.

11. An operational method of a controller which makes a power converter start up normally, wherein the controller comprises a detection circuit, an upper-bridge power supply pre-charge circuit and a driving signal generation circuit, the operational method comprising:
the detection circuit detecting a feedback voltage during the power converter starting up, and adjusting a lower-bridge turning-on time of a lower-bridge switch driving signal of a lower-bridge switch of the power converter according to the feedback voltage;
the upper-bridge power supply pre-charge circuit generating the lower-bridge switch driving signal according to the lower-bridge turning-on time;
the upper-bridge power supply pre-charge circuit stopping generating the lower-bridge switch driving signal when the feedback voltage meets a first predetermined condition, wherein the first predetermined condition relates to a feedback peak voltage of the feedback voltage; and
the driving signal generation circuit generating the lower-bridge switch driving signal to the lower-bridge switch and an upper-bridge switch driving signal to an upper-bridge switch of the power converter to make the power converter operate normally after upper-bridge power supply pre-charge circuit stops generating the lower-bridge switch driving signal.

12. The operational method of claim 11, wherein the first predetermined condition is that the feedback peak voltage of the feedback voltage is less than a reference voltage or the feedback peak voltage of the feedback voltage maintains at a stable value within a predetermined number cycles.

13. The operational method of claim 11, wherein the lower-bridge turning-on time of the lower-bridge switch driving signal has a minimum turning-on time or a maximum turning-on time.

14. The operational method of claim 11, wherein the feedback voltage relates to a resonant capacitor voltage on a resonant capacitor coupled to the lower-bridge switch and a resonant capacitor current flowing through the lower-bridge switch.

15. The operational method of claim 11, wherein the detection circuit gradually increases the lower-bridge turning-on time of the lower-bridge switch driving signal according to the feedback voltage or adjusts the lower-bridge turning-on time of the lower-bridge switch driving signal according to the feedback voltage.

16. An operational method of a controller which makes a power converter start up normally, wherein the controller comprises a detection circuit, an upper-bridge power supply pre-charge circuit and a driving signal generation circuit, the operational method comprising:
the detection circuit detecting a peak value of a resonant capacitor current flowing through a lower-bridge switch of the power converter during the power converter starting up;
the upper-bridge power supply pre-charge circuit adjusting a lower-bridge turning-on time of a lower-bridge switch driving signal of the lower-bridge switch according to the peak value of the resonant capacitor current, and generating the lower-bridge switch driving signal according to the lower-bridge turning-on time;
the upper-bridge power supply pre-charge circuit stopping generating the lower-bridge switch driving signal when the peak value of the resonant capacitor current meets a second predetermined condition; and
the driving signal generation circuit generating the lower-bridge switch driving signal to the lower-bridge switch and an upper-bridge switch driving signal to an upper-bridge switch of the power converter to make the power converter operate normally after the upper-bridge power supply pre-charge circuit stops generating the lower-bridge switch driving signal.

17. The operational method of claim 16, wherein the detection circuit receives the resonant capacitor current from outside the controller, and the second predetermined condition is that the peak value of the resonant capacitor current is less than a reference current.

18. The operational method of claim 16, wherein the upper-bridge power supply pre-charge circuit gradually increases the lower-bridge turning-on time of the lower-bridge switch driving signal according to the resonant capacitor current or adjusts the lower-bridge turning-on time of the lower-bridge switch driving signal according to the resonant capacitor current.
